(19) United States
(12) Patent Application Publication
(10) Pub. No.: US 2018/0190986 A1
(43) Pub. Date: Jul. 5, 2018

(54) HALOGENATED GRAPHENE NANOPLATELETS, AND PRODUCTION AND USES THEREOF

(71) Applicant: Albemarle Corporation, Baton Rouge, LA (US)

(72) Inventors: Yinzhi Zhang, Charlotte, NC (US); John C. Parks, Baton Rouge, LA (US); Clancy R. Kadrmas, Zachary, LA (US); Joseph M. O'Day, Waxhaw, NC (US)

(21) Appl. No.: 15/740,162

(22) PCT Filed: Jun. 30, 2016
(86) PCT No.: PCT/US2016/040369

§ 371 Date: Dec. 27, 2017

Related U.S. Application Data
(60) Provisional application No. 62/186,420, filed on Jun. 30, 2015.

(51) Int. Cl. H01M 4/587; H01M 4/38; H01M 4/62; H01M 4/133; H01M 4/134; H01M 10/0525; H01M 4/36; C01B 32/225; C01B 32/19; C08K 9/02; C08K 3/16; C10M 103/02; B01J 21/18; H01G 11/36

(52) U.S. Cl. CPC H01M 4/587; B82Y 30/00; H01M 4/623; H01M 4/625; H01M 4/133; H01M 4/134; H01M 10/0525; H01M 4/366; C01B 32/225; C01B 32/19; C08K 9/02; C08K 3/16; C10M 103/02; B01J 21/18; H01G 11/36; C01B 2204/04; C01B 2204/24; C01B 2204/32; C01B 2204/22; C10M 2201/0423; C10N 2250/08; H01M 4/386

(57) ABSTRACT

Halogenated graphene nanoplatelets that are characterized by having, except for the carbon atoms forming the perimeters of the graphene layers of the nanoplatelets, (i) graphene layers that are free from any element or component other than sp2 carbon, and (ii) substantially defect-free graphene layers; the total content of halogen in the nanoplatelets is about 5 wt % or less calculated as bromine and based on the total weight of the nanoplatelets. Processes for producing such nanoplatelets and various end uses for such nanoplatelets are also described. Halogenated exfoliated graphite having a total content of halogen of about 5 wt % or less calculated as bromine and based on the total weight of the halogenated exfoliated graphite and processes for producing the halogenated exfoliated graphite are also provided.

### TECHNICAL FIELD

This invention relates to new halogenated graphene nanoplatelets having superior characteristics, to new process technology for preparing halogenated graphene nanoplatelets, and to applications for which such halogenated graphene nanoplatelets are well suited.

### BACKGROUND

Graphene nanoplatelets are nanoparticles consisting of layers of graphene that have a platelet shape. Graphene nanoplatelets are believed to be a desirable alternative to carbon nanotubes for use in similar applications.

There are two primary methods of production of graphene nanoplatelets known in the art, ‘bottom up’ and ‘top down’. Bottom up methods build the graphene nanoplatelets one atom or layer at a time with such methods as chemical vapor deposition, which are time-consuming and expensive. The other method, the top down method, starts with natural or synthetic graphite uses a variety of processes to separate the numerous stacked layers to few-layer or one-layer particles. Some common techniques are known, including peeling (“scotch tape”), liquid phase exfoliation, and intercalation/exfoliation. Intercalation/exfoliation is a step by step process of intercalation of a substance into graphite and vaporization or decomposition of that substance from the graphite, which expands, separates, and exfoliates the graphite layers, forming platelets. Various substances have been employed in the art to intercalate the graphite.

Although several types of graphene nanoplatelets are commercially available, the desire for graphene nanoplatelets having better properties along with superior performance capabilities exists. This invention is deemed to satisfy this desire.

### SUMMARY OF THE INVENTION

This invention provides halogenated graphene nanoplatelets that are characterized by having, except for the carbon atoms forming the perimeters of the graphene layers of the nanoplatelets, (i) graphene layers that are free from any element or component other than sp² carbon, and (ii) substantially defect-free graphene layers; the total content of halogen in the nanoplatelets is about 5 wt % or less calculated as bromine and based on the total weight of the nanoplatelets. The invention also provides halogenated exfoliated graphite; the total content of halogen in the exfoliated graphite is about 5 wt % or less calculated as bromine and based on the total weight of the halogenated exfoliated graphite.

In a preferred embodiment, the halogenated graphene nanoplatelets are halogenated graphene nanoplatelets that have chemically-bound halogen at the perimeters of the graphene layers of the nanoplatelets.

In another preferred embodiment, the halogenated graphene nanoplatelets are brominated graphene nanoplatelets that have chemically-bound bromine at the perimeters of the graphene layers of the nanoplatelets.

The above halogenated graphene nanoplatelets also have high purity and little or no detectable chemically-bound oxygen impurities. Thus, the halogenated graphene nanoplatelets obtainable according to this invention qualify for the description or classification of “pristine”. In addition, the halogenated graphene nanoplatelets of this invention are virtually free from any structural defects. This can be attributed at least in part to the pronounced uniformity and structural integrity of the sp² graphene layers of the halogenated graphene nanoplatelets of this invention. Among additional advantageous features of these nanoplatelets are superior electrical conductivity and superior physical properties as compared to commercially available halogen-containing graphene nanoplatelets. Moreover, no solvents are required during the synthesis of the halogenated graphene nanoplatelets of this invention, nor is an intermediate step of forming a graphitic oxide needed to form the halogenated graphene nanoplatelets of the invention.

New synthesis process technology is also provided by this invention. Thus in one of its process embodiments, this invention provides a continuous process for the production of halogenated graphene platelets. Advantageously, the process technology described herein for producing halogenated graphene nanoplatelets is reproducible, and is deemed capable of being performed on a commercial scale.

Accordingly, this invention provides in one of its embodiments a process for preparing halogenated graphene nanoplatelets which are free from any element or component other than sp² carbon, except for the carbon atoms forming the perimeters of the graphene layers of the nanoplatelets. So far as known, this is the first time such halogenated nanoplatelets have been formed by any process. It is believed that the absence of defects is attributable at least in part to the high purity of the halogenated nanoplatelets of this invention, which are essentially free of any oxygen or other elements except for the halogen(s) utilized in their preparation. Of these halogenated graphene nanoplatelets, the preferred nanoplatelets are brominated graphene nanoplatelets, i.e., nanoplatelets which have been formed using elemental bromine (Br₂) as the halogen source.

As will be seen hereinafter, two-layered brominated graphene nanoplatelets have been obtained and found to possess only or nearly only sp² carbon except for the carbon atoms forming the perimeters of the graphene layers. These two-layered brominated graphene nanoplatelets exhibit better conductivity, better physical properties, and other highly desirable characteristic as compared to commercially-available nanoplatelets.

These and other embodiments and features of this invention will be still further apparent from the ensuing description, drawings, and appended claims.

### BRIEF DESCRIPTION OF THE DRAWINGS

FIG. 1 is a high resolution transmission electron microscopy (TEM) image of a portion of a brominated graphene nanoplatelet of the invention.

FIG. 2 is a set of x-ray powder diffraction patterns for a series of bromine-intercalated graphite formed in the processes of this invention, and an x-ray powder diffraction pattern for graphite.

FIG. 3 is a high resolution transmission electron microscopy (TEM) image of a two-layered brominated graphene nanoplatelet of this invention.

FIG. 4A is a photograph of a brominated exfoliated graphite, formed in the process of this invention, dispersed in water. FIG. 4B is a photograph of graphite on the surface of water.

FIG. 5 is a graph of thermogravimetric analysis (TGA) results in nitrogen for brominated exfoliated graphite produced in a process of this invention, and comparative results for natural graphite.

FIG. 6 is a graph of thermogravimetric analysis (TGA) results in air for brominated graphene nanoplatelets produced in a process of this invention, and comparative results for the graphite starting material.

### FURTHER DETAILED DESCRIPTION OF THE INVENTION

As known in the art, and as used throughout this document, the term “intercalation” means putting a substance between layers of graphite. The terms “intercalating agent” and “intercalant” are used interchangeably throughout this document. As used throughout this document, and as known in the art, the term “exfoliation” means removing the substance that is between layers of graphite, and increasing the separation of the graphite layers.

By “pristine or nearly pristine” is meant that either there is no observable damage, or if there is any damage to the graphene layers as shown by either high resolution transmission electron microscopy (TEM) or by atomic force microscopy (AFM), such damage is negligible, i.e., it is so insignificant as to be unworthy of consideration. For example, any such damage has no observable detrimental effect on the nanoelectronic properties of the halogenated graphene nanoplatelets. Generally, any damage in the halogenated graphene nanoplatelets originates from damage present in the graphite from which the halogenated graphene nanoplatelets are made; any damage and/or impurities from the graphite starting material remains in the product halogenated graphene nanoplatelets.

In the practice of this invention, the intercalating agents are diatomic halogen molecules. The terms “diatomic halogen molecule” and “diatomic halogen” as used throughout this document include elemental halogen compounds and diatomic interhalogen compounds.

Throughout this document, Br₂ is sometimes referred to as “elemental bromine” and F₂ is sometimes referred to as “elemental fluorine”.

The diatomic halogen molecules for use in forming the halogenated graphene nanoplatelets of this invention generally include elemental bromine (Br₂), elemental fluorine (F₂), iodine monochloride (ICl), iodine monobromide (IBr), iodine monofluoride (IF), or a mixture of any two or more of these halogen compounds. Bromine (Br₂) is a preferred diatomic halogen molecule.

The term “halogenated” in halogenated graphene nanoplatelets, as used throughout this document, refers to graphene nanoplatelets in which Br₂, F₂, ICl, IBr, IF, or any combinations thereof were used in preparing the graphene nanoplatelets. Similarly, for halogenated exfoliated graphite, the term “halogenated” refers to exfoliated graphite in which Br₂, F₂, ICl, IBr, IF, or any combinations thereof were used in preparing the exfoliated graphite.

Halogenated exfoliated graphite is an embodiment of this invention, and can be obtained by the processes of this invention. Brominated exfoliated graphite is a preferred halogenated exfoliated graphite.

Halogenated graphene nanoplatelets are an embodiment of this invention, and can be obtained by the processes of this invention. Brominated graphene nanoplatelets are preferred halogenated graphene nanoplatelets.

The halogenated graphene nanoplatelets of the invention comprise graphene layers and are characterized by having, except for the carbon atoms forming the perimeters of the graphene layers of the nanoplatelets, (i) graphene layers that are free from any element or component other than sp² carbon, and (ii) substantially defect-free graphene layers. The total content of halogen in the halogenated graphene nanoplatelets is about 5 wt % or less calculated as bromine and based on the total weight of the halogenated graphene nanoplatelets.

The phrase “free from any element or component other than sp² carbon” indicates that the impurities are usually at or below the parts per million (ppm; wt/wt) level, based on the total weight of the nanoplatelets. Typically, the halogenated graphene nanoplatelets have about 3 wt % or less oxygen, preferably about 1 wt % or less oxygen; the oxygen observed in the halogenated graphene nanoplatelets is believed to be an impurity originating in the graphite starting material.

The phrase “substantially defect-free” indicates that the graphene layers of the halogenated graphene nanoplatelets are substantially free of structural defects including holes, five-membered rings, and seven-membered rings.

In some embodiments, the halogenated graphene nanoplatelets of the invention comprise chemically-bound halogen at the perimeters of the graphene layers of the nanoplatelets. The halogen atoms that can be chemically-bound at the perimeters of the graphene layers of the halogenated graphene nanoplatelets include fluorine, chlorine, bromine, iodine, and mixtures thereof; bromine is preferred.

While the total amount of halogen present in the nanoplatelets of this invention may vary, the total content of halogen in the nanoplatelets is about 5 wt % or less, and is preferably in the range equivalent to a total bromine content (or calculated as bromine) in the range of about 0.001 wt % to about 5 wt % bromine, based on the total weight of the nanoplatelets, which is determined by the amounts and atomic weights of the particular diatomic halogen composition being used. More preferably, the total content of halogen in the nanoplatelets is in the range equivalent to a total bromine content in the range of about 0.01 wt % to about 4 wt % bromine based on the total weight of the nanoplatelets. In some embodiments, the total content of halogen in the nanoplatelets is preferably in the range equivalent to a total bromine content in the range of about 0.001 wt % to about 5 wt % bromine, more preferably about 0.01 wt % to about 4 wt % bromine, based on the total weight of the nanoplatelets.

The total amount of halogen present in the halogenated exfoliated graphite of this invention, may vary, and is about 5 wt % or less, and preferably in the range equivalent to a total bromine content (or calculated as bromine) in the range of about 0.001 wt % to about 5 wt %, more preferably in the range of about 0.01 wt % to about 4 wt %, or preferably having a total halogen content in the range of about 0.001 wt % to about 5 wt %, more preferably in the range of about 0.01 wt % to about 4 wt %, calculated as bromine, based on the total weight of the halogenated exfoliated graphite.

As used throughout this document, the phrases “as bromine,” “reported as bromine,” “calculated as bromine,” and analogous phrases for the halogens refer to the amount of halogen, where the numerical value is calculated for bromine, unless otherwise noted. For example, elemental fluorine may be used, but the amount of halogen in the halogenated exfoliated graphite and halogenated graphene nanoplatelets is stated as the value for bromine.

In a preferred embodiment of this invention, the halogenated, especially brominated, nanoplatelets comprise few-layered graphenes. By “few-layered graphenes” is meant that a grouping of a stacked layered graphene nanoplatelet contains up to about 10 graphene layers, preferably about 1 to about 5 graphene layers. Such few-layered graphenes typically have superior properties as compared to corresponding nanoplatelets composed of larger numbers of layers of graphene. Halogenated graphene nanoplatelets that comprise two-layered graphenes are particularly preferred, especially two-layered brominated graphene nanoplatelets.

Particularly preferred halogenated graphene nanoplatelets are brominated graphene nanoplatelets which comprise few-layered or two-layered brominated graphene nanoplatelets in which the distance between the layers is about 0.335 nm as determined by high resolution transmission electron microscopy (TEM). Brominated graphene nanoplatelets wherein said nanoplatelets comprise two-layered graphene in which the thickness of said two-layered is about 0.7 nm as determined by Atomic Force Microscopy (AFM) are also particularly preferred.

Moreover, the halogenated graphene nanoplatelets of this invention often have a lateral size as determined by Atomic Force Microscopy (AFM) in the range of about 0.1 to about 50 microns, preferably about 0.5 to about 50 microns, more preferably about 1 to about 40 microns. In some applications, a lateral size of about 1 to about 20 microns is preferred for the halogenated graphene nanoplatelets. For halogenated graphene nanoplatelets, larger lateral size often provides better conductivity and increased physical or mechanical strength. Lateral size is the linear size of the halogenated graphene nanoplatelets in a direction perpendicular to the layer thickness.

The halogenated graphene nanoplatelets, especially brominated graphene nanoplatelets, of this invention have enhanced dispersibility in water. It is theorized that this property is provided by the chemically-bound halogen at the perimeters of the graphene layers of the nanoplatelets.

Another advantageous feature of the halogenated graphene nanoplatelets of this invention, especially the brominated graphene nanoplatelets, is superior thermal stability. In particular, the brominated graphene nanoplatelets exhibit a negligible weight loss when subjected to thermogravimetric analysis (TGA) at temperatures up to about 800° C. under an inert atmosphere. At 900° C. under an inert atmosphere, the TGA weight loss of brominated graphene nanoplatelets is typically about 4 wt % or less, usually about 3 wt % or less. Further, in this invention, the TGA weight loss temperatures of the brominated graphene nanoplatelets under an inert atmosphere have been observed to decrease as the amount of bromine increases. The inert atmosphere can be e.g., helium, argon, or nitrogen; nitrogen is typically used and is preferred.

A preferred embodiment of this invention is brominated graphene nanoplatelets having enhanced dispersibility in water, and/or comprising two-layered graphene nanoplatelets, while also having a negligible weight loss when subjected to thermogravimetric analysis (TGA) at temperatures up to about 800° C. under an anhydrous nitrogen atmosphere as described herein. Preferably, the TGA weight loss of the brominated graphene nanoplatelets is about 4 wt % or less at 900° C. under an inert atmosphere, more preferably about 3 wt % or less at 900° C. under an inert atmosphere.

The halogenated exfoliated graphite is believed to be comprised of agglomerated and/or stacked layers of halogenated graphene nanoplatelets. In the halogenated exfoliated graphite, the halogen content and preferences therefor are the same as described for the halogenated graphene nanoplatelets, except that the total weight is that of the halogenated exfoliated graphite.

The processes of this invention for producing halogenated exfoliated graphite and part of the processes for producing halogenated graphene nanoplatelets are conducted in the absence of water and oxygen. These processes comprise
I) contacting a diatomic halogen selected from elemental bromine (Br₂), elemental fluorine (F₂), iodine monochloride (ICl), iodine monobromide (IBr), iodine monofluoride (IF), and a mixture of any two or more of these, with graphite flakes to form solids comprising halogen-intercalated graphite; and
II) feeding, into a reaction zone free from oxygen and water vapor, halogen-intercalated graphite while
   (a) rapidly heating the halogen-intercalated graphite to, and maintaining the halogen-intercalated graphite at, a temperature of about 400° C. or above, and
   (b) maintaining contact of a diatomic halogen selected from Br₂, F₂, ICl, IBr, IF, or a mixture of any two or more of these, with the halogen-intercalated graphite within said reaction zone; and
   withdrawing halogenated exfoliated graphite from the reaction zone, the halogenated exfoliated graphite having a total halogen content of about 5 wt % or less;
III) optionally repeating steps I) and II) in sequence one or more times;
IV) optionally subjecting said halogenated exfoliated graphite to a halogenated graphene nanoplatelet liberation procedure to form halogenated graphene nanoplatelets;
V) when step IV) is performed, optionally repeating steps I), II), and optionally IV) in sequence one or more times.

When halogenated exfoliated graphite is the desired product, the halogenated graphene nanoplatelet liberation procedure is not conducted.

The process may be conduct as a batch process or as a continuous process. When carried out as a continuous process, the feeding of the halogen-intercalated graphite is preferably continuous, and preferably the withdrawing of the halogenated exfoliated graphite from the reaction zone is at a rate enabling the continuous feeding of halogen-intercalated graphite into the reaction zone. When the feeding is continuous, slight interruptions in the feed are acceptable provided that the duration of the interruption is sufficiently small as to cause no material disruption in the reaction.

Typically, the environment in which steps I) and II) of the processes of this invention are conducted is a moisture-free, oxygen-free environment. A moisture-free, oxygen-free environment may be obtained by purging containers and reaction zones prior to use with an inert gas such as argon, helium, or, preferably, nitrogen. In some instances, an inert gas (argon, helium, or, preferably, nitrogen) may be used as a carrier gas. Trace amounts of oxygen and water (on the order of a few parts per hundred) can be tolerated during the processes of this invention. Step IV) of the process does not need to be conducted in a moisture-free, oxygen-free environment.

The term “reaction zone”, as used throughout this document, refers to an area where the halogen-intercalated graphite is maintained at about 400° C. or above. Step II) of the process may be conducted in any reactor (reaction zone) that enables rapid heating of the halogen-intercalated graphite that is fed into the reactor such as a tubular reactor, e.g., a drop reactor.

The graphite starting material in the practice of this invention is usually in the form of powder or, preferably, flakes. The particular form of the graphite (powder, flakes, etc.) and the source of the graphite (natural or synthetic) does not appear to affect the results obtained. The graphite has an average particle size of about 50 μm (˜270 standard U.S. mesh) or more. Preferably, the graphite has an average particle size of about 100 μm (˜140 standard U.S. mesh) or more. More preferably, the graphite has an average particle size of about 200 μm (70 standard U.S. mesh) or more, still more preferably about 250 μm (60 standard U.S. mesh) or more. It has been found that graphite with larger average particle sizes permit greater amounts of the diatomic halogen to be intercalated into the graphite, exfoliation occurs more easily, and products containing fewer layers of graphene are obtained (as compared to smaller-sized graphite flakes). It has also been found that graphite with average particle sizes of about 20 μm or less do not expand appreciably when subjected to the processes of this invention. Defects and/or impurities in the graphite starting material remain in the product halogenated exfoliated graphite and halogenated graphene nanoplatelets.

Expanded graphite is a commercially available product, and is the result of one set of intercalation and exfoliation steps, and may contain some oxygen from its production process. Commercially available expanded graphite can be used in the processes of this invention.

The diatomic halogen molecules in the processes of this invention usually include elemental bromine (Br₂), elemental fluorine (F₂), iodine monochloride (ICl), iodine monobromide (IBr), iodine monofluoride (IF), or a mixture of any two or more of these halogen compounds. Elemental bromine (Br₂) is preferred as the diatomic halogen in these processes. When the diatomic halogen is IF, step I) is usually conducted at low temperatures, generally below room temperature.

Step I) of the process is carried out by contacting graphite and the diatomic halogen(s). In the practice of this invention, the diatomic halogen may be used in gaseous form or in liquid form. The diatomic halogen can be supplied as a gas, or as a solid or liquid which is then vaporized to provide the gaseous form. Step I) is conducted in the absence of water and oxygen. Temperatures during step I) are usually ambient (about 18° C. to about 25° C.).

In a preferred embodiment of step I), the graphite is placed in a fluidized bed, and the diatomic halogen gas flows through the fluidized bed of graphite, forming halogen-intercalated graphite.

In step II), exfoliation and halogenation of the halogen-intercalated graphite occurs, to form halogenated exfoliated graphite. The diatomic halogen gas present in step II) is usually provided by exfoliation of the halogen-intercalated graphite. Step II) is conducted in the absence of water and oxygen.

The halogenated exfoliated graphite is rapidly heated to, and maintained at, 400° C. or above by having the reaction zone at about 400° C. or above and/or by heating the halogenated exfoliated graphite in step II). The heating in step II) includes methods such as conduction, convection, and exposing the halogen-intercalated graphite to radiation (e.g., infra-red or microwave), or any combination thereof. In step II), the heating is preferably at a rate of about 2° C./second or more, more preferably about 50° C./second or more, even more preferably about 100° C./second or more, and still more preferably about 250° C./second or more. Preferably the heating rates are in the range of about 2° C./second to about 1000° C./second, more preferably about 50° C./second to about 1000° C./second, and even more preferably about 250° C./second to about 1000° C./second.

In step II), residence times are generally in the range of about 1 second to about 5 hours, or about 1 second to about 60 seconds, or about 0.1 minutes to about 2 hours, or about 1 hour to about 5 hours. Shorter residence times are preferred for faster heating rates, and longer residence times are preferred for slower heating rates.

When steps I) and II) are repeated, preferably, a total of three sets of steps I) and II) are performed on the graphite (two additional sets of steps I and II). More (or fewer) sets of steps I) and II) can be performed, if desired. When sets of steps I), II), and IV) are repeated in sequence one or more times, it is preferred that a total of three sets of steps I), II), and IV) are performed on the graphite (two additional sets of steps I, II, and IV). More (or fewer) sets of steps I), II), and IV) can be performed, if desired. Optionally, steps I) and II) can be repeated one or more times after step IV), or combinations of repeating of steps I) and II) only and steps I), II), and IV) can be carried out.

A convenient method for transferring particles such as graphite, halogen-intercalated graphite, halogenated exfoliated graphite, and/or halogenated graphene nanoplatelets is by blowing them into the desired location. An apparatus that is useful to separate diatomic halogen(s) from solid particles such as graphite, halogen-intercalated graphite, halogenated exfoliated graphite, and/or halogenated graphene nanoplatelets is a cyclone.

Pressure conditions for steps I) and II) are typically ambient pressure or superatmospheric pressure; the process can also be carried out at reduced pressure or under vacuum. Superatmospheric pressures are preferably in the range of about 15 psi (1×10⁵ Pa) to about 1000 psi (6.9×10⁶ Pa), more preferably about 20 psi (1.4×10⁵ Pa) to about 100 psi (6.9×10⁵ Pa). In some embodiments of this invention, the graphite may be at reduced pressure, e.g., about 5 torr (6.6×10² Pa) to about 700 torr (9.3×10⁴ Pa), more preferably about 10 torr (1.3×10³ Pa) to about 600 torr (8×10⁴ Pa).

At ambient pressure, temperatures in the reaction zone in step II) are typically about 400° C. or above, preferably about 400° C. to about 1200° C., more preferably about 600° C. to about 1100° C., even more preferably about 750° C. to about 1000° C. Lower temperatures can be employed when step II) is carried out under reduced pressure. Generally, temperatures in the reaction zone are below about 3000° C.

When forming halogenated graphene nanoplatelets, the halogenated exfoliated graphite is subjected to a halogenated graphene nanoplatelet liberation procedure, which is typically one or more particle size reduction techniques; when employing more than one particle size reduction technique, the techniques can be combined. The particle size reduction techniques include, but are not limited to, grinding, dry or wet milling, high shear mixing, and ultrasonication. When grinding or milling and ultrasonication are performed on the halogenated graphene nanoplatelets, the grinding or milling is preferably performed prior to the ultrasonication. Solvents for ultrasonication are typically one or more polar monoprotic solvents. Suitable solvents for the ultrasonication include N-methyl-2-pyrrolidinone, dimethylformamide, acetonitrile, and the like. Indeed, even water, optionally and preferably with a surfactant, can be used in the ultrasonication step. One or more ionic and/or nonionic surfactants can be used; suitable surfactants are known in the art. Conventional separation techniques can be used to separate the sonicated halogenated graphene nanoplatelets from the solvent (e.g., filtration or centrifugation).

It is not necessary to keep the halogenated exfoliated graphite or the halogenated graphene nanoplatelets in a water-free and/or oxygen-free environment.

At the end of the process, the halogenated exfoliated graphite, when desired, or the halogenated graphene nanoplatelets are collected, usually in the form of a slurry, wetcake, or powder. When in powdered form, the halogenated exfoliated graphite or halogenated graphene nanoplatelets can be captured by a filter or another particle collection device.

The diatomic halogen gas released from the halogen-intercalated graphite during the process can be removed from the reaction zone after step II) of the process. If desired, the diatomic halogen gas released during the process can be recovered, and optionally recycled to the process.

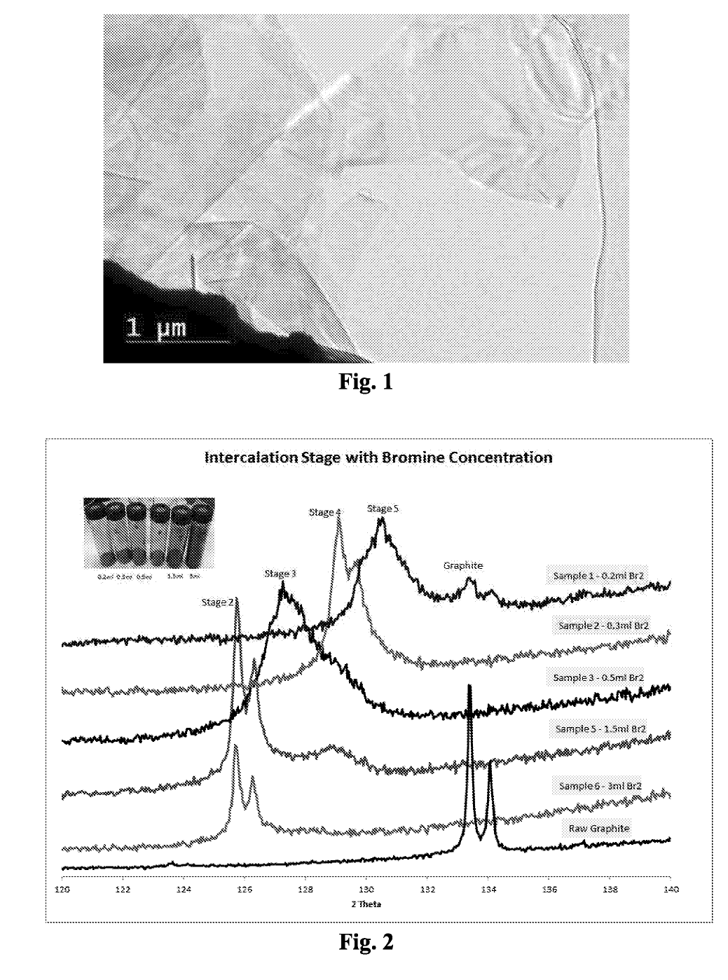

Referring now to the Figures, as mentioned above, FIG. 1 is a high resolution transmission electron microscopy (TEM) image of a portion of a brominated graphene nanoplatelet of the invention, and this TEM image shows the large lateral size of brominated graphene nanoplatelets obtained in this invention.

In FIG. 2, a set of x-ray powder diffraction patterns for a series of bromine-intercalated graphite formed in the processes of this invention, and a pattern for graphite are shown. In this series, a fixed amount of graphite was reacted/contacted with increasing amounts of elemental bromine. The patterns are arranged from lowest to highest amount of bromine from top to penultimate trace; the bottom trace is for graphite. The products for which the x-ray diffraction patterns are shown are bromine-intercalated graphites produced as in step I) of the processes of this invention; see also Example 2 below.

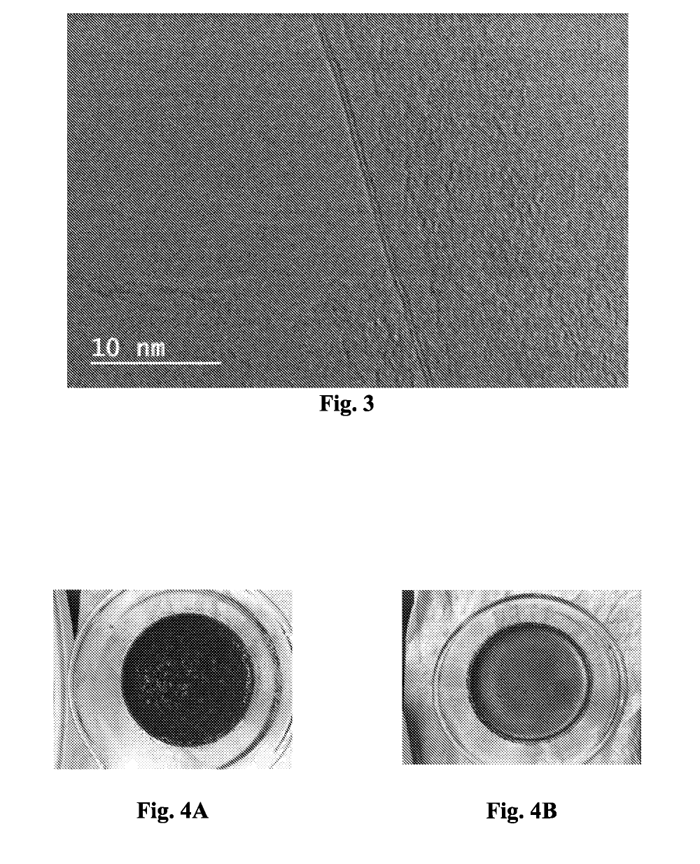

In FIG. 3, the high resolution transmission electron microscopy (TEM) image shows the two layers of a two-layered brominated graphene nanoplatelet of this invention as two parallel ridges or lines in the image; the distance between the two was determined to be about 0.335 nm (see Example 2).

FIGS. 4A and 4B are top views. A comparison of FIG. 4A, brominated exfoliated graphite in water, and FIG. 4B, graphite and water, shows that the sample in FIG. 4A has a lumpy texture, due to the dispersion of the brominated exfoliated graphite in the water. In contrast, the sample in FIG. 4B has a smooth texture because the graphite is on the surface of the water. Halogenated exfoliated graphite (e.g., brominated exfoliated graphite) is the product of step II) of the processes of this invention; see also Example 2 below.

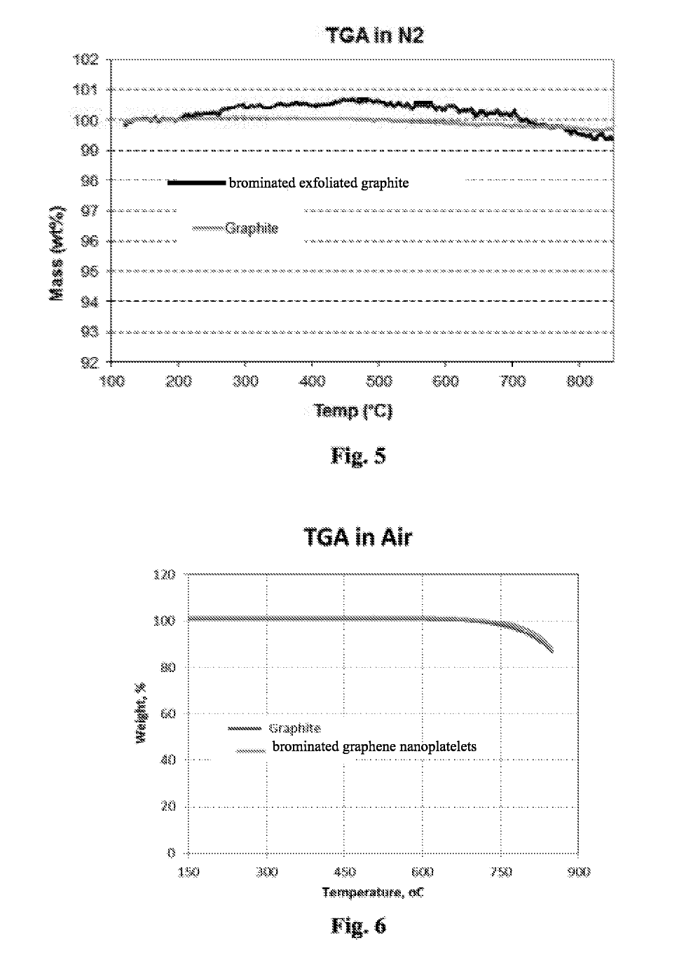

In FIG. 5, the TGA under N₂ for the brominated exfoliated graphite shows that it has very desirable thermal characteristics. Comparison of the TGA result for the brominated exfoliated graphite to the result for graphite shows that the brominated exfoliated graphite has similar thermal behavior to that of graphite. The brominated exfoliated graphite for FIG. 5 was prepared as in steps I), II), and III) of the processes of this invention. See also Example 2 below.

FIG. 6 shows that the TGA weight loss in air for brominated graphene nanoplatelets of this invention is similar to the TGA weight loss in air for the graphite starting material. See Example 2 below.

In this connection, for brominated graphene nanoplatelets of the invention, dispersibility and thermal behavior are expected to be quite similar to the dispersibility in water and TGA results found for the brominated exfoliated graphite. In other words, the halogenated graphene liberation procedure as in step IV) of the processes of the invention is not expected to affect the dispersibility in water or the thermal behavior.

Because of their enhanced performance capabilities, the halogenated graphene nanoplatelets of this invention are capable of use in energy storage applications from small scale (e.g., lithium ion battery anode applications, including batteries for phones and automobiles) to bulk scale (mass energy storage, e.g., for power plants), or energy storage devices such as batteries and accumulators. In this connection, it is reasonable to suggest that the halogenated graphene nanoplatelets provided by this invention may be used in a variety of energy storage applications that remain under development. Examples of such energy storage applications include silicon anodes, solid state electrolytes, magnesium ion batteries, sodium ion batteries, lithium sulfur batteries, lithium air batteries, and lithium ion capacitor devices. It is conceivable that one or more of such devices may outperform lithium ion technology.

In some embodiments of this invention, energy storage devices comprising an electrode comprising halogenated graphene nanoplatelets, preferably brominated graphene nanoplatelets, of this invention are provided. The electrode can be an anode or cathode. When the electrode is an anode, it may be a silicon anode. The electrode comprising the halogenated graphene nanoplatelets can be present in a lithium ion battery, a lithium sulfur battery, a lithium ion capacitor, a supercapacitor, a sodium ion battery, or a magnesium ion battery.

In some embodiments, the electrode is an anode or cathode that contains carbon black (active material in an anode; additive in a cathode), where halogenated graphene nanoplatelets comprise about 0.1 wt % or more of the carbon black in the anode or cathode, based on the total weight of the carbon black in the anode or cathode. Preferably, the anode comprises about 0.1 wt % to about 98 wt % halogenated graphene nanoplatelets; more preferably, the halogenated graphene nanoplatelets are brominated graphene nanoplatelets.

In other embodiments, the electrode containing the halogenated graphene nanoplatelets further comprises one or more of:

at least one substance selected from carbon, silicon, and/or one more silicon oxides;

a binder;

a conductive aid;

carbon black; and

a current collector.

Preferably, the electrode is an anode; more preferably, the halogenated graphene nanoplatelets are brominated graphene nanoplatelets. Also preferred is an amount of about 0.1 wt % or more halogenated graphene nanoplatelets in the electrode. In these embodiments, the anode preferably comprises a binder. Typical binders include styrene butadiene rubber and polyvinylidene fluoride (PVDF; also called polyvinylidene difluoride). In preferred embodiments for these anodes, the improvement comprises having halogenated graphene nanoplatelets, preferably brominated graphene nanoplatelets, take the place of about 10 wt % to about 100 wt % of the conductive aid and/or carbon black, or the improvement comprises having halogenated graphene nanoplatelets, preferably brominated graphene nanoplatelets, take the place of about 1 wt % or more of the carbon, silicon, and/or one more silicon oxides.

The term “carbon” in connection with energy storage devices, as used throughout this document, refers to natural graphite, purified natural graphite, synthetic graphite, hard carbon, soft carbon, carbon black, or any combinations thereof.

In some energy storage devices, brominated graphene nanoplatelets of this invention may act as a current collector for the electrode (either cathode or anode), while in other energy storage devices, brominated graphene nanoplatelets of this invention may act as a conductive additive in the electrode.

In some thermoset or thermoplastic compositions, halogenated graphene nanoplatelets of this invention may function as a thermal management additive. In other thermoset or thermoplastic compositions, halogenated graphene nanoplatelets of this invention may function as a conductive additive. In still other thermoset or thermoplastic compositions, halogenated graphene nanoplatelets of this invention may function as a physical property enhancement additive.

Halogenated graphene nanoplatelets of this invention may also be useful in lubricant compositions for various applications. See in this connection U.S. Pat. No. 8,865,113 for a discussion of the drawbacks of conventional elasto-hydrodynamic lubricants and lubricants for polishing and reduction of asperities.

Halogenated graphene nanoplatelets of this invention may also be used in catalyst systems, where the halogenated graphene nanoplatelets can be used as a carbocatalyst, in metal-free catalysis, in photocatalysis, or as a catalyst support.

The following Examples are presented for purposes of illustration, and are not intended to impose limitations on the scope of this invention.

### Sample Characterization and Performance Testing

In the experimental work described in the Examples, the samples used were analyzed by the following methods in order to evaluate their physical characterization and performance

Atomic Force Microscopy (AFM)—The AFM instrument used was a Dimension Icon® AFM made by Bruker Corporation (Billerica, Mass.) in ScanAsyst® mode with a ScanAsyst® probe. Its high-resolution camera and X-Y positioning permit fast, efficient sample navigation. The samples were dispersed in dimethylformamide (DMF) and coated on mica, and then analyzed under AFM.

High Resolution Transmission Electron Microscopy (TEM)—A JEM-2100 LaB6 TEM (JEOL USA, Peabody, Mass.) was used. Operation parameters include a 200 kV accelerating voltage for imaging and an Energy Dispersive Spectroscopy (EDS) for TEM (Oxford Instruments plc, United Kingdom) for elemental analysis. The samples were first dispersed in dimethylformamide (DMF) and coated on copper grid.

Scanning Electron Microscopy (SEM)—Electron imaging and elemental microanalysis were done in a JSM 6300FXV (JEOL USA, Peabody, Mass.) scanning electron microscope at 5 to 25 keV. The specimens were coated with a thin layer of gold or carbon prior to examination. Energy dispersive X-ray spectra were obtained using an Inca® system (Oxford Instruments plc, United Kingdom) equipped with an energy-dispersive x-ray spectrometer with a Si(Li) detector with a 5-terminal device incorporating a low noise junction field effect transistor and a charge restoration mechanism, referred to as a PentaFET Si(Li) detector (manufacturer unclear). Semiquantitative concentrations were calculated from the observed intensities. The accuracy of the values is estimated to be plus or minus twenty percent. All values are in weight percent.

Powder X-ray Diffractometer (for XRD)—The sample holder used contained a silicon zero background plate set in a mount that could be isolated with a polymethylmethacrylate (PMMA) dome sealed with an 0-ring. The plate was coated with a very thin film of high vacuum grease (Apiezon®; M&I Materials Ltd., United Kingdom) to improve adhesion, and the powdered sample was quickly spread over the plate and flattened with a glass slide. The dome and O-ring were installed, and the assembly transferred to the diffractometer. The diffraction data was acquired with Cu kα radiation on a D8 Advance (Bruker Corp., Billerica, Mass.) equipped with an energy-dispersive one-dimensional detector (LynxEye XE detector; Bruker Corp., Billerica, Mass.). Repetitive scans were taken over the 100 to 140° 2Θ angular range with a 0.04° step size and a counting time of 0.5 second per step. Total time per scan was 8.7 minutes. Peak profile analysis was performed with Jade 9.0 software (Materials Data Incorporated, Livermore, Calif.).

N₂-isotherm—An accelerated surface area and porosimetry system (model no. ASAP 2420; Micromeritics Instrument Corporation, Norcross, Ga.) was used to measure the nitrogen adsorption at a liquid nitrogen temperature of 77 K. The amount of adsorbed nitrogen was measured as a function of the applied vapor pressure, which comprised the adsorption isotherm. The BET (Brunauer-Emmett-Teller) surface area was derived from the nitrogen adsorption isotherm.

TGA—The TGA analysis was conducted using a simultaneous DSC/TGA Analyzer with autosampler and silicon carbide furnace (model no. STA 449 F3, Netzsch-Geratebau GmbH, Germany), which was located inside a glove box. The samples were pre-dried at 120° C. for 20 minutes, then heated up to 850° C. at 10° C./min under a flow of nitrogen or air. The remaining weight together with the temperature was recorded.

Lithium-ion battery test—The half-cell tests were conducted with the electrolyte of 1M lithium hexafluorophosphate solution in ethylene carbonate/dimethyl carbonate (LiPF₆ in EC/DMC) (50/50), the tested voltage range is 0 to 3 V. The anode was made of the test samples, as described below, and lithium was used as counter electrode. The commercial battery-grade graphite was tested as baseline.

The active material, either graphite or 50/50 graphite/brominated graphene Nanoplatelets, was mixed with binder (polyvinylidene fluoride; PVDF) and carbon black in N-methyl-2-pyrrolidinone (NMP), the resultant paste was coated on a copper foil (with the thickness of about 20 micron) using a Doctor Blade available for example from MTI Corporation, from which multiple coin cells of about 2 cm diameter were assembled. The capacity at different charge/discharge rate was measured using an 8-channel battery analyzer (0.002-1 mA, up to 5 V; model no. BST8-WA, MTI Corporation, Richmond, Calif.).

Supercapacitor test—The supercapacitor tests were conducted with the electrolyte of 2M lithium bis-(trifluoromethylsulfonyl)imide (LiTFSI) in EC/DMC (50/50), the tested voltage range is 0 to 2.5 V. A commercially available powdered activated carbon (PAC) of surface area about 800 m²/g was used as a baseline. The active material, either the commercial PAC or mixture of PAC with the brominated graphene nanoplatelets, was mixed with binder polyvinylidene fluoride (PVDF) and carbon black in N-methyl-2-pyrrolidone (NMP), the resultant paste was coated on a copper foil (with the thickness of about 20 micron) using a Doctor Blade, from which multiple coin cells batteries of about 2 cm diameter were assembled. The cyclic voltammetry (CV) curves were measured with a potentiostat (model no. SP-150, Bio-Logic Science Instruments SAS, Claix, France) at 20 mV/s scan rate from 0 to 2.5 V and repeated 20 times, and the capacitance was calculated from the integration of the 20^{th} discharge curve.

### EXAMPLE 1

Several individual 2-gram samples of natural graphite, with 35% of the particles larger than 300 microns, and 85% of the particles larger than 180 microns (Asbury Carbons, Asbury, N.J.), were contacted with 0.2 mL, 0.3 mL, 0.5 mL, 1 mL, 1.5 mL or 3 mL of liquid bromine (Br₂) for 24 hours at room temperature. After 24 hours, the color in vials from the bromine vapor was darker as the bromine vapor concentration in the vials increased. The resultant bromine-intercalated materials were analyzed by X-ray powder diffraction (XRD). As seen in FIG. 2, with visibly observable amounts of bromine vapor, different bromine-intercalated compounds were formed. Once the bromine vapor reached saturation, as shown by the presence of liquid bromine, “stage-2” bromine-intercalated graphite was formed. In the intercalation step of all the rest of the these Examples, except when specifically mentioned otherwise, saturated bromine vapor pressure was maintained during the intercalation step in order to obtain stage-2 bromine-intercalated graphite.

### EXAMPLE 2

Natural graphite (4 g), of the same particle size as used in Example 1, was contacted with 4 g of liquid bromine for 64 hours at room temperature. Excess liquid bromine was present to ensure the formation of stage-2 bromine-intercalated graphite. All of the stage-2 bromine-intercalated graphite was continuously fed during a period of 45 minutes into a drop tube reactor (5 cm diameter) that had been pre-purged with nitrogen, while the reactor was maintained at 900° C. Bromine vapor pressure was maintained in the drop reactor for 60 minutes while the temperature of the reactor was kept at 900° C. The solid material in the reactor was cooled with a nitrogen flow.

Some of the cooled solid material (3 g) was contacted with liquid bromine (4 g) for 16 hours at room temperature with excess liquid bromine present to ensure the formation of stage-2 bromine-intercalated graphite. Then all of this stage-2 bromine-intercalated graphite was continuously fed within 30 minutes into a drop tube reactor (5 cm diameter) that had been pre-purged with nitrogen. The reactor was maintained at 900° C. during the feeding of the stage-2 bromine-intercalated graphite. Bromine vapor pressure was maintained in the drop reactor for 60 minutes while the temperature of the reactor was kept at 900° C. The solid material in the reactor was cooled with a nitrogen flow.

Some of the cooled solid material just obtained (2 g) was contacted with liquid bromine (2.5 g) for 16 hours at room temperature with excess liquid bromine present to ensure the formation of stage-2 bromine-intercalated graphite. Then all of this stage-2 bromine-intercalated graphite was continuously fed within 20 minutes into a drop tube reactor (5 cm diameter) that had been pre-purged with nitrogen. The reactor was maintained at 900° C. during the feeding of the stage-2 bromine-intercalated graphite. Bromine vapor pressure was maintained in the drop reactor for 60 minutes while the temperature of the reactor was kept at 900° C. The solid material in the reactor was cooled with a nitrogen flow.

Part of the cooled solid material just obtained was dispersed in dimethylformamide (DMF) and subjected to ultrasonication for 6 minutes, and then analyzed with TEM and AFM. The TEM results show that the brominated graphene nanoplatelets comprised two-layered graphene, and the TEM analysis also showed that the distance (d002) between two graphene layers was about 0.335 nm (see FIG. 3), which means these graphene layers were damage-free, containing only sp² carbon in the graphene layers. The AFM analysis confirmed that the sample comprised 2-layered graphene, and also showed that the thickness of the 2-layered graphene was about 0.7 nm, which confirms that the graphene layers are damage-free and there are only sp² carbons within the graphene layers.

An EDS analysis revealed that there was 0.9 wt % bromine in the sample, as well as 97.7 wt % carbon, 1.3 wt % oxygen, and 0.1 wt % chlorine.

The sample was found to comprise two-layered brominated graphene nanoplatelets having at least a lateral size of greater than 4 microns; the sample also contained 4-layered brominated graphene nanoplatelets with the lateral size of about 9 microns.

Some of the cooled solid material from the third set of intercalation and exfoliation steps, rather than being subjected to ultrasonication, was subjected to TGA under nitrogen. The weight loss of the sample up to 800° C. was about <1%. Some of the graphite starting material was also analyzed by TGA. The weight loss from graphite was also negligible up to 800° C. in N₂. Thus it was concluded that the negligible weight loss in N₂ up to 800° C. is another characteristic feature of the brominated graphene nanoplatelets of this invention.

Some of the cooled solid material from the third set of intercalation and exfoliation steps, rather than being subjected to ultrasonication, was subjected to TGA under air. The weight loss of the sample started at about 700° C. Some of the graphite starting material was also analyzed by TGA. The weight loss from graphite was also observed to start at about 700° C. in air. See FIG. 6.

Another portion of the cooled solid material from the third set of intercalation and exfoliation steps (0.2 grams) and graphite (0.2 g) were mixed with separate 250 mL amounts of water. The cooled solid material (brominated exfoliated graphite) dispersed easily in water, while the graphite floated on top of the water. These results indicate that the brominated graphene nanoplatelets of this invention possess enhanced dispersibility in water.

### EXAMPLE 3

Natural graphite (4 g), of the same particle size as used in Example 1, was contacted with 6 g of liquid bromine for 48 hours at room temperature. Excess liquid bromine was present to ensure the formation of stage-2 bromine-intercalated graphite. All of the stage-2 bromine-intercalated graphite was continuously fed during a period of 60 minutes into a drop tube reactor (5 cm diameter) that had been pre-purged with nitrogen, while the reactor was maintained at 900° C. Bromine vapor pressure was maintained in the drop reactor for 60 minutes while the temperature of the reactor was kept at 900° C. The solid material in the reactor was cooled with a nitrogen flow.

Some of the cooled solid material (3 g) was contacted with liquid bromine (4.5 g) for 16 hours at room temperature with excess liquid bromine present to ensure the formation of stage-2 bromine-intercalated graphite. Then all of this stage-2 bromine-intercalated graphite was continuously fed during 30 minutes into a drop tube reactor (5 cm diameter) that had been pre-purged with nitrogen. The reactor was maintained at 900° C. during the feeding of the stage-2 bromine-intercalated graphite. Bromine vapor pressure was maintained in the drop reactor for 30 minutes while the temperature of the reactor was kept at 900° C. The solid material in the reactor was cooled with a nitrogen flow.

Some of the cooled solid material just obtained (2 g) was contacted with liquid bromine (3 g) for 24 hours at room temperature with excess liquid bromine present to ensure the formation of stage-2 bromine-intercalated graphite. Then all of this stage-2 bromine-intercalated graphite was continuously fed during 20 minutes into a drop tube reactor (5 cm diameter) that had been pre-purged with nitrogen. The reactor was maintained at 900° C. during the feeding of the stage-2 bromine-intercalated graphite. Bromine vapor pressure was maintained in the drop reactor for 60 minutes while the temperature of the reactor was kept at 900° C. The solid material in the reactor was cooled with a nitrogen flow.

Some of the cooled solid material from the third set of intercalation and exfoliation steps was analyzed by a wet titration method for bromine content, and there was 2.5 wt % of bromine in the sample.

Part of the cooled solid material from the third set of intercalation and exfoliation steps (1 g) was mixed with 50 mL of NMP, sonicated, and then filtered to obtain brominated graphene nanoplatelets. The filter cake was vacuum dried at 130° C. for 12 hours.

### EXAMPLE 4

Brominated graphene nanoplatelets from Example 3 (0.4 g), graphite (0.4 g), carbon black (0.1 g) and PVDF (0.1 g) were mixed in NMP and coated on a copper foil. 6 coin cells of 2 cm diameter were assembled with the anode from this coating on copper foil for Li-ion battery testing. The cells were initially charge/discharged at C/20 once, then C/2 for 20 times, then 10 C for 500 times. The average capacity of the cell at C/2 charge/discharge rate at 20^{th} cycle is 210 mAh per gram of active material, and 262 mAh per gram of brominated graphene nanoplatelets, and the average capacity of the cell at 10 C charge/discharge rate at 500^{th} cycle is 64 mAh per gram of active material, and 98 mAh per gram of brominated graphene nanoplatelets.

### COMPARATIVE EXAMPLE 1

Graphite (0.8 g), carbon black (0.1 g), and PVDF (0.1 g) were mixed in NMP and coated on a copper foil. 6 coin cells of 2 cm diameter were assembled with the anode from this coating for Li-ion battery testing. The cells were initially charge/discharged at C/20 once, then C/2 for 20 times, then 10 C for 500 times. The average capacity of the cell at C/2 charge/discharge rate at 20th cycle was 159 mAh per g of active material (graphite), and the average capacity of the cell at 10 C charge/discharge rate at 500th cycle was 30 mAh/g of activate material (graphite).

### EXAMPLE 5

Brominated graphene nanoplatelets from Example 3 (0.2 g), powdered activated carbon (0.6 g), carbon black (0.1 g) and PVDF (0.1 g) were mixed in NMP and coated on a copper foil. 9 symmetric coin cells of 2 cm diameter were assembled with both electrodes from this coating for supercapacitor testing. The average capacitance of the cells was 46.5 F per g of active material.

### EXAMPLE 6

Brominated graphene nanoplatelets from Example 3 (0.1 g), powdered activated carbon (0.8 g), and PVDF (0.1 g) were mixed in NMP and coated on a copper foil. 9 symmetric coin cells of 2 cm diameter were assembled with both electrodes from this coating for supercapacitor testing. The average capacitance of the cells is 63 F per g of active material.

### COMPARATIVE EXAMPLE 2

Powdered activated carbon (0.8 g), carbon black (0.1 g), and PVDF (0.1 g) were mixed in NMP and coated on a copper foil. 9 symmetric coin cells of 2 cm diameter were assembled with both electrodes from this coating for supercapacitor testing. The average capacitance of the cells is 53 F per g of active material.

Components referred to by chemical name or formula anywhere in the specification or claims hereof, whether referred to in the singular or plural, are identified as they exist prior to coming into contact with another substance referred to by chemical name or chemical type (e.g., another component, a solvent, or etc.). It matters not what chemical changes, transformations and/or reactions, if any, take place in the resulting mixture or solution as such changes, transformations, and/or reactions are the natural result of bringing the specified components together under the conditions called for pursuant to this disclosure. Thus the components are identified as ingredients to be brought together in connection with performing a desired operation or in forming a desired composition. Also, even though the claims hereinafter may refer to substances, components and/or ingredients in the present tense (“comprises”, “is”, etc.), the reference is to the substance, component or ingredient as it existed at the time just before it was first contacted, blended or mixed with one or more other substances, components and/or ingredients in accordance with the present disclosure. The fact that a substance, component or ingredient may have lost its original identity through a chemical reaction or transformation during the course of contacting, blending or mixing operations, if conducted in accordance with this disclosure and with ordinary skill of a chemist, is thus of no practical concern.

The invention may comprise, consist, or consist essentially of the materials and/or procedures recited herein.

As used herein, the term “about” modifying the quantity of an ingredient in the compositions of the invention or employed in the methods of the invention refers to variation in the numerical quantity that can occur, for example, through typical measuring and liquid handling procedures used for making concentrates or use solutions in the real world; through inadvertent error in these procedures; through differences in the manufacture, source, or purity of the ingredients employed to make the compositions or carry out the methods; and the like. The term “about” also encompasses amounts that differ due to different equilibrium conditions for a composition resulting from a particular initial mixture. Whether or not modified by the term “about”, the claims include equivalents to the quantities.

Except as may be expressly otherwise indicated, the article “a” or “an” if and as used herein is not intended to limit, and should not be construed as limiting, the description or a claim to a single element to which the article refers. Rather, the article “a” or “an” if and as used herein is intended to cover one or more such elements, unless the text expressly indicates otherwise.

This invention is susceptible to considerable variation in its practice. Therefore the foregoing description is not intended to limit, and should not be construed as limiting, the invention to the particular exemplifications presented hereinabove.

1. Halogenated graphene nanoplatelets comprising graphene layers and characterized by having, except for the carbon atoms forming the perimeters of the graphene layers of the nanoplatelets, (i) graphene layers that are free from any element or component other than sp² carbon, and (ii) substantially defect-free graphene layers, wherein the total content of halogen in the nanoplatelets is about 5 wt % or less calculated as bromine and based on the total weight of the nanoplatelets.

2. Halogenated graphene nanoplatelets as in claim 1 that have chemically-bound halogen at the perimeters of the graphene layers of the nanoplatelets.

3. Halogenated graphene nanoplatelets as in claim 1 that are brominated graphene nanoplatelets that have chemically-bound bromine at the perimeters of the graphene layers of the nanoplatelets.

4. (canceled)

5. Halogenated graphene nanoplatelets of claim 1 wherein the nanoplatelets are brominated graphene nanoplatelets.

6. Brominated graphene nanoplatelets of claim 5 wherein said nanoplatelets have a total bromine content in the range of about 0.001 wt % to about 5 wt %, based on the total weight of the nanoplatelets.

7. Brominated graphene nanoplatelets of claim 5 wherein said nanoplatelets comprise few-layered graphenes and/or wherein said nanoplatelets comprise two-layered graphenes.

8. (canceled)

9. Brominated graphene nanoplatelets of claim 7 wherein said nanoplatelets have a distance between the layers of about 0.335 nm as determined by high resolution transmission electron microscopy

10. Brominated graphene nanoplatelets of claim 5 wherein said nanoplatelets comprise two-layered graphenes have a thickness of about 0.7 nm as determined by atomic force microscopy.

11. (canceled)

12. Brominated graphene nanoplatelets of claim 5 which exhibit a weight loss of about 4 wt % or less when subjected to thermogravimetric analysis at 900° C. under an inert atmosphere.

13. Brominated graphene nanoplatelets as in claim 5 having a lateral size as determined by atomic force microscopy in the range of about 0.1 to about 50 microns.

14. Halogenated graphene nanoplatelets of claim 1 having no detectable chemically-bound oxygen impurities.

15. Halogenated exfoliated graphite having a total content of halogen of about 5 wt % or less calculated as bromine and based on the total weight of the halogenated exfoliated graphite.

16. A process for producing halogenated exfoliated graphite in the absence of water and oxygen, which process comprises:
I) contacting a diatomic halogen selected from elemental bromine, elemental fluorine, iodine monochloride, iodine monobromide, iodine monofluoride, and a mixture of any two or more of these, with graphite flakes to form solids comprising halogen-intercalated graphite; and
II) feeding, into a reaction zone free from oxygen and water vapor, halogen-intercalated graphite while
(a) rapidly heating the halogen-intercalated graphite to, and maintaining the halogen-intercalated graphite at, a temperature of about 400° C. or above, and
(b) maintaining contact of a diatomic halogen selected from Br₂, F₂, ICl, IBr, IF, or a mixture of any two or more of these, with the halogen-intercalated graphite within said reaction zone; and
withdrawing halogenated exfoliated graphite from the reaction zone,
the halogenated exfoliated graphite having a total halogen content of about 5 wt % or less, calculated as bromine and based on the total weight of the halogenated exfoliated graphite;
and
III) optionally repeating steps I) and II) in sequence one or more times

17. A process as in claim 16 which further comprises
IV) subjecting said halogenated exfoliated graphite to a halogenated graphene nanoplatelet liberation procedure to form halogenated graphene nanoplatelets; and
V) optionally repeating steps I), II), and optionally IV) in sequence one or more times.

18. A process as in claim 16 wherein said halogen-intercalated graphite is formed in a fluidized bed and/or wherein the halogenated exfoliated graphite has a total halogen content in the range of about 0.001 wt % to about 5 wt %, calculated as bromine, based on the total weight of the halogenated exfoliated graphite.

19. (canceled)

20. A process as in claim 17 wherein the halogenated graphene nanoplatelets produced thereby have a total halogen content in the range of about 0.001 wt % to about 5 wt %, calculated as bromine, based on the total weight of the nanoplatelets.

21. A process as in claim 16 wherein the graphite flakes have a lateral size of about 50 microns or more.

22. A process as in claim 16 wherein said diatomic halogen used in the process is elemental bromine.

23. A process as in claim 16 wherein the process is conducted as a continuous process.

24. A process as in claim 16 wherein the process is conducted as a batch process.

25. An energy storage device comprising an electrode comprised of halogenated graphene nanoplatelets, which nanoplatelets comprise graphene layers and are characterized by having, except for the carbon atoms forming the perimeters of the graphene layers of the nanoplatelets, (i) graphene layers that are free from any element or component other than sp² carbon, and (ii) substantially defect-free graphene layers, wherein the total content of halogen in the nanoplatelets is about 5 wt % or less calculated as bromine and based on the total weight of the nanoplatelets.

26. An energy storage device as in claim 25 wherein said energy storage device is a lithium ion battery, a lithium sulfur battery, a lithium air battery, a lithium ion capacitor, a supercapacitor, a sodium ion battery, or a magnesium ion battery.

27. An energy storage device as in claim 25 wherein said electrode is an anode, or wherein said electrode is a cathode.

28. An energy storage device as in claim 27 wherein said anode is a silicon anode, and/or wherein said anode comprises one or more of:
a substance selected from carbon, silicon, and/or one more silicon oxides;
a binder;
a conductive aid;
carbon black; and
a current collector.

29. An energy storage device as in claim 25 wherein said electrode is an anode or cathode containing carbon black, and brominated graphene nanoplatelets comprise about 0.1 wt % or more of the carbon black in the anode or cathode, based on the total weight of the carbon black in the anode or cathode.

30. (canceled)

31. An energy storage device as in claim 25 wherein said energy storage device comprises a solid state electrolyte.

32. (canceled)

33. An energy storage device as in claim 25 wherein said halogenated graphene nanoplatelets are brominated graphene nanoplatelets.

34. A thermoplastic or thermoset composition containing in the range of about 0.1 to about 30 wt % of halogenated graphene nanoplatelets comprising graphene layers and characterized by having, except for the carbon atoms forming the perimeters of the graphene layers of the nanoplatelets, (i) graphene layers that are free from any element or component other than sp² carbon, and (ii) substantially defect-free graphene layers.

35. A composition as in claim 34 wherein said halogenated graphene nanoplatelets are brominated graphene nanoplatelets.

36. A lubricant composition comprising halogenated graphene nanoplatelets comprising graphene layers and characterized by having, except for the carbon atoms forming the perimeters of the graphene layers of the nanoplatelets, (i) graphene layers that are free from any element or component other than sp² carbon, and (ii) substantially defect-free graphene layers.

37. A catalyst system comprising halogenated graphene nanoplatelets comprising graphene layers and characterized by having, except for the carbon atoms forming the perimeters of the graphene layers of the nanoplatelets, (i) graphene layers that are free from any element or component other than sp² carbon, and (ii) substantially defect-free graphene layers.

38. A catalyst system as in claim 37 wherein the halogenated graphene nanoplatelets are employed as a carbocatalyst, in metal-free catalysis, in photocatalysis, or as a catalyst support.
